(19) United States
(12) Patent Application Publication
(10) Pub. No.: US 2025/0244451 A1
(43) Pub. Date: Jul. 31, 2025

(54) SYSTEMS AND METHODS FOR RESOLVING POSITIONAL OFFSETS BETWEEN ADJACENT LIDAR DATA SETS

(71) Applicant: Toyota Jidosha Kabushiki Kaisha, Aichi-ken (JP)

(72) Inventors: Edward Higgins, Redmond, WA (US); Matthew R. Sayler, Tacoma, WA (US); Jaspal Singh, Hicksville, NY (US)

(73) Assignee: Toyota Jidosha Kabushiki Kaisha, Aichi-ken (JP)

(21) Appl. No.: 18/426,999

(22) Filed: Jan. 30, 2024

(51) Int. Cl. G01S 7/497; G01S 7/48; G01S 7/51; G01S 17/06; G01S 17/89; G01S 17/931

(52) U.S. Cl. CPC G01S 7/497; G01S 7/4808; G01S 17/06; G01S 17/89; G01S 7/51; G01S 17/931

(57) ABSTRACT

In one embodiment, a method for resolving positional offsets between adjacent lidar data sets includes defining a first polygon for a first lidar data set and defining a second polygon for a second lidar data set, forming a first buffer around the first polygon and a second buffer around the second polygon, defining an overlap region between the first buffer and the second buffer, for each lidar point of the first lidar data set or the second lidar data set within the overlap region, determining a lidar point pair by finding a nearest neighbor of the other of the first lidar data set or the second lidar data set, determining a positional offset for each lidar point pair, and determining a polygon offset based at least in part on the positional offsets for the lidar point pairs.

### BACKGROUND

A high-definition map is a map that includes data captured from one or more sources, such as lidar scanners. Lidar scanners produce lidar data in the form of lidar points that represent objects within the environment. More particularly, lidar scanners emit light (e.g., infrared light) into an environment and have one or more detectors that receive and detect light emitted by the scanner that has been reflected by objects within the environment. The distance of an object from the lidar scanner, and thus the location of an object within the environment, is determined by the amount of time it takes for the reflected light to be received by the one or more detectors.

The resulting lidar data of the environment is in the form of a plurality of lidar points, often referred to as a point cloud. Features within the lidar data, such as objects like cars, signs and the like, may be derived from the lidar data. These features can be represented by vectors within the high-definition map. For example, lane lines of a road may be represented by digital vectors within a vector layer of the high-definition map.

Large environments may be scanned by a lidar scanner in different scan sessions over a period of time, and/or scanned by multiple lidar scanners, which creates individual lidar data sets for a particular environment. However, lidar scans at different times and/or by different lidar scanners may result in positional offsets between adjacent lidar data sets. For example, a first lidar data set may be vertically offset from an adjacent second lidar data set, which could create an erroneous ridge or drop-off at the interface between the first and second lidar data sets.

Therefore, alternative systems and methods for resolving positional offsets between adjacent lidar data sets may be desired.

### SUMMARY

In one embodiment, a method for resolving positional offsets between adjacent lidar data sets includes defining a first polygon for a first lidar data set and defining a second polygon for a second lidar data set, forming a first buffer around the first polygon and a second buffer around the second polygon, defining an overlap region between the first buffer and the second buffer, for each lidar point of the first lidar data set or the second lidar data set within the overlap region, determining a lidar point pair by finding a nearest neighbor of the other of the first lidar data set or the second lidar data set, determining a positional offset for each lidar point pair, and determining a polygon offset based at least in part on the positional offsets for the lidar point pairs.

In another embodiment, a system for resolving positional offsets between adjacent lidar data sets includes one or more processors. The system also includes a memory storing instructions that, when executed by the one or more processors, cause the one or more processors to define a first polygon for a first lidar data set and defining a second polygon for a second lidar data set, form a first buffer around the first polygon and a second buffer around the second polygon, define an overlap region between the first buffer and the second buffer, for each lidar point of the first lidar data set or the second lidar data set within the overlap region, determine a lidar point pair by finding a nearest neighbor of the other of the first lidar data set or the second lidar data set, determine a positional offset for each lidar point pair, and determine a polygon offset based at least in part on the positional offsets for the lidar point pairs.

In another embodiment, a system for resolving positional offsets between adjacent lidar data sets includes a lidar scanner operable to scan an environment to generate lidar points that define lidar data sets. The system also includes one or more processors. The system also includes a memory storing instructions that, when executed by the one or more processors, cause the one or more processors to receive lidar points from the lidar scanner, where the lidar points define a first lidar data set and a second lidar data set, define a first polygon for the first lidar data set and defining the second polygon for a second lidar data set, form a first buffer around the first polygon and a second buffer around the second polygon, define an overlap region between the first buffer and the second buffer, for each lidar point of the first lidar data set or the second lidar data set within the overlap region, determine a lidar point pair by finding a nearest neighbor of the other of the first lidar data set or the second lidar data set, determine a positional offset for each lidar point pair, and determine a polygon offset based at least in part on the positional offsets for the lidar point pairs.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example lidar scanner operating in an environment according to one or more embodiments described and illustrated herein.

FIG. 2A illustrates a top view example adjacent polygons representing adjacent lidar data sets according to one or more embodiments described and illustrated herein.

FIG. 2B illustrates an elevation view of the example adjacent polygons of FIG. 2A according to one or more embodiments described and illustrated herein.

FIG. 3 illustrates buffers surrounding the polygons of FIG. 2A with an overlapping region according to one or more embodiments described and illustrated herein.

FIG. 4 illustrates two example lidar points of two different lidar data sets according to one or more embodiments described and illustrated herein.

FIG. 5 illustrates a flowchart of an example method for resolving positional offsets in adjacent lidar data sets according to one or more embodiments described and illustrated herein.

FIG. 6 illustrates an example system for resolving positional offsets in adjacent lidar data sets according to one or more embodiments described and illustrated herein.

### DETAILED DESCRIPTION

Embodiments of the present disclosure are directed to systems and methods for resolving offsets between adjacent lidar data sets. Lidar data sets are generated by operating one or more lidar scanners that use infrared light to generate a plurality of lidar points referred to as a point cloud. The point cloud defines objects within an environment, such as roads, trees, buildings, benches, vehicles, and the like. In some cases, a portion of an environment is scanned by a lidar scanner at one point in time, and another portion of the environment is scanned by the lidar scanner at another point in time. Each scan produces an individual lidar data set comprising a plurality of lidar points. As another example, a first lidar scanner may scan a first portion of the environment to generate a first lidar data set and a second lidar scanner may scan a second portion of the environment to generate a second lidar data set. Thus, individual lidar sets may be separated by time or created by different lidar scanners.

Such differences may cause a positional offset in three dimensional space due to a variety of factors, such as the calibration of the different lidar scanners, differences in environmental conditions, different operator settings or use of the lidar scanners, and the like. These positional offsets can cause errors within a high-definition map (HD map). As described in more detail below, a vertical offset (i.e., an elevation difference) between adjacent lidar data sets may provide an erroneous drop-off within a road of the HD map that does not exist in the physical environment.

Embodiments of the present disclosure provide systems and methods for efficiently resolving these positional offsets by comparing individual lidar points between adjacent lidar data sets that are present within a common overlap region between the lidar data sets. Offset values between lidar point pairs are then used to determine an overall positional offset between the two lidar data sets. A correction factor or factors can then be applied to resolve the positional offsets within the HD map.

Various embodiments of systems and methods for resolving positional offsets between adjacent lidar data sets are described in detail below.

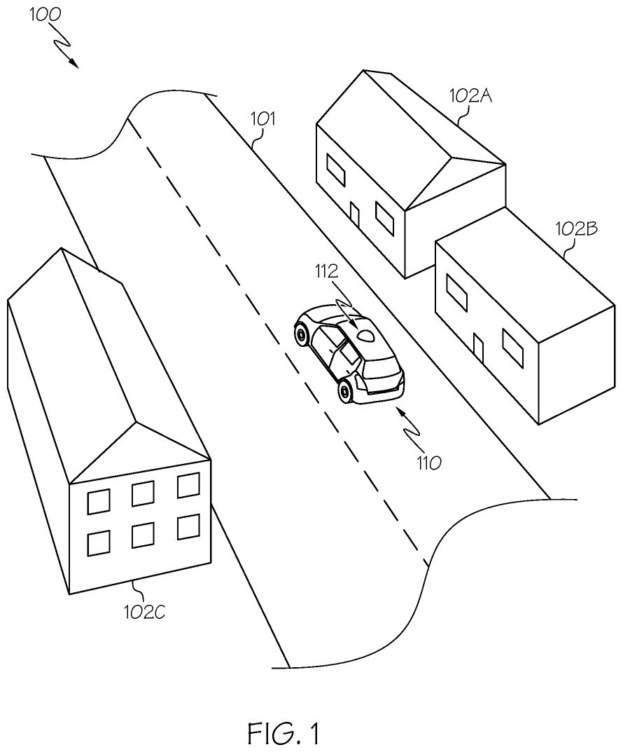

Referring now to FIG. 1, an example environment 100 for lidar data is being generated by a lidar scanning system 112 is illustrated. The environment 100 includes a road 101, buildings 102A-102C and any other features, such as signs, curbs, trees, lane lines, and the like. In the illustrated embodiment, the lidar scanner 112 is mounted on a vehicle 110, which drives through the environment 100. However, it should be understood that the lidar scanner 112 may be operated without being positioned on a vehicle. The lidar scanner 112 emits an array of infrared beams, and detects the return of the beams and their times of flight to generate a point cloud of lidar points in three-dimensional space.

Features within the environment, such as the road 101 and buildings 102A-102C, are represented by points within the point cloud. These features can then be further defined as polygons, where vertices of the polygons are individual points of the point cloud. These polygons and their points are stored in a vector dataset.

There may be more than one vector datasets representing an environment. For example, as stated above, temporally separated individual lidar scans of the environment by a lidar scanner 112 may be performed. Differences between the different lidar scans may introduce differences between the data, such as the result of noise, or actual changes within the environment. For example a sign may not have been present in a first lidar scan but present in a second lidar scan.

The individual lidar data sets can be represented by polygons. A concave hull of an individual lidar data set defines the size and shape of the polygon. An environment may be represented in a HD map by a plurality of polygons representing a plurality of lidar data sets. The polygons may be any size or shape.

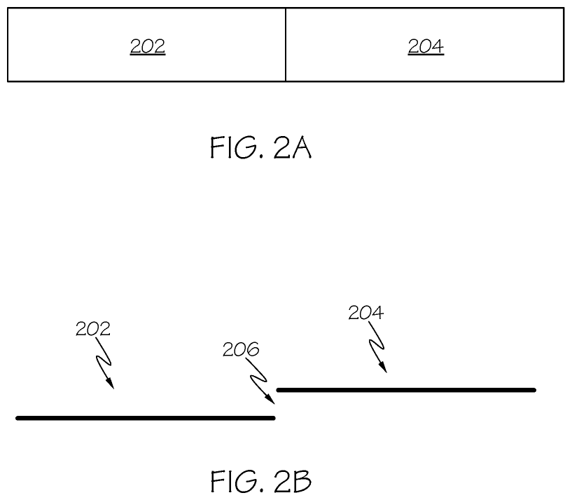

Adjacent polygons are those that have edges that border one another. FIG. 2A illustrates an overhead view of two simple rectangular polygons in the form of a first polygon 202 and a second polygon 204 that are adjacent to one another. It should be understood that embodiments are not limited to rectangular polygons. The first polygon 202 and the second polygon 204 represent a first lidar data set and a second lidar data set, respectively.

The first and second polygons may represent lidar data sets of a road. Thus, one would expect that there is not an abrupt vertical transition from the first polygon 202 to the second polygon 204 in the road. However, such abrupt vertical transitions may occur for the reasons stated above. A vertical offset may cause the HD map to indicate a ledge or a drop off at the mating edges of the first polygon 202 and the second polygon 204 even when such features do not physically exist in the environment.

FIG. 2B illustrates an elevation view of the first polygon 202 and the second polygon 204. Due to factors such as temporally separated lidar scans, scans made by different lidar scanners, or any other factor, there is a vertical offset 206 between the first polygon 202 and the second polygon 204 at their interface. As shown, the first polygon 202 is lower in elevation than the second polygon 204. Such a vertical offset 206 is an error within the resulting HD map and can create unnecessary problems for users and vehicles relying on the HD map. Thus, it is desirable to correct the vertical offset (as well as any lateral offsets) in the HD map such that it more accurately represents the environment.

Embodiments of the present disclosure analyze the lidar points of each adjacent lidar data set to determine an overall vertical offset between adjacent lidar data sets represented by the adjacent polygons. Generally, positional values of a lidar point within one lidar data set is compared with a nearest neighbor lidar point within the other lidar data set. These are referred to a “lidar point pairs.” Embodiments minimize the number of lidar point pairs by establishing an overlap region between adjacent polygons.

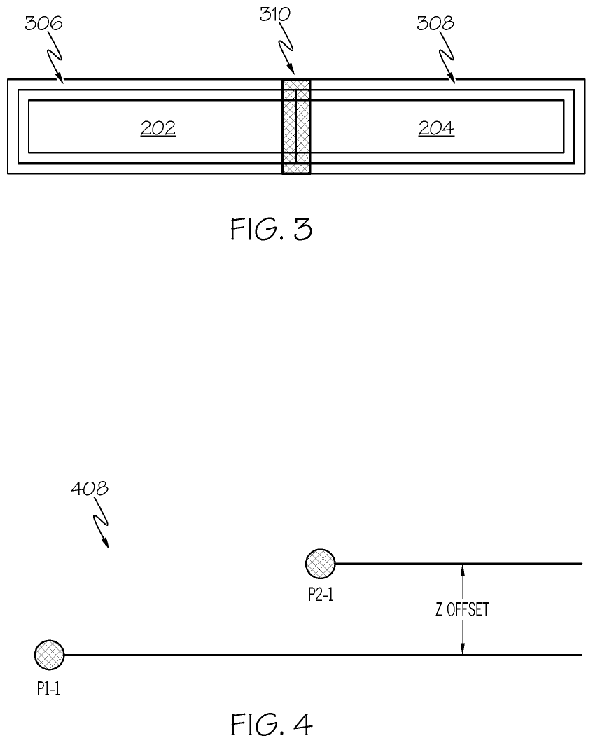

FIG. 3 illustrates an overlap overlapping region 310 between the first polygon and the second polygon 204 of the example shown in FIG. 2. As described in detail below, only the lidar points within the overlap overlapping region 310 are used to form lidar point pairs. Use of the overlapping region 310 significantly reduces the amount of data analyzed, and thus significantly reduces the amount of time and computing resources needed to perform the analysis.

In embodiments, the system generates a buffer around each polygon, such as the first polygon 202 and the second polygon 204. As shown in FIG. 3, a first buffer 306 is formed around the first polygon 202 and a second buffer 308 is formed around the second polygon 204. This may be performed by expanding the volumes of the first and second polygons 202, 204. The resulting first buffer 306 and second buffer 308 create an overlapping region 310. To reduce processing time and resources, only the lidar points from both lidar data sets that are within the overlapping region 310 are analyzed to correct for any positional offsets.

Individual lidar point pairs are generated by determining a nearest neighbor for a lidar point in one lidar data set with another lidar point in the other lidar data set. FIG. 4 illustrates an example lidar point pair 402 comprising a lidar point P1-1 of the first lidar data set represented by the first polygon 202 and a lidar point P2-1 of the second lidar data set represented by the second polygon 204. These two lidar points are found to be the proper lidar points of a lidar point pair 402 by a nearest neighbor algorithm. The nearest neighbor algorithm finds the nearest neighbor of a lidar point in one lidar data set to a lidar point in another lidar data set. Embodiments are not limited by a type of nearest neighbor algorithm. In some embodiments, the nearest neighbor is calculated by summing the x, y and z distances between points and selecting the point having the lowest summed value. It should be understood that other nearest neighbor algorithms may be utilized.

Once the two points of a lidar point pair are determined, an offset between them is calculated. In the example of FIG. 4, a vertical offset 206 (i.e., a z-offset or an elevation offset) is determined. Lidar point P2-1 is offset from lidar point P1-1 by some z-direction distance (i.e., a vertical offset distance). Lidar point pairs are formed for all lidar points within the overlapping region 310, or for some sub-set of the lidar points within the overlapping region 310.

The vertical offsets 206 for all or some sub-set of the lidar point pairs are used to determine an overall polygon offset between adjacent polygons, such as the first polygon 202 and the second polygon 204. In one example, the polygon offset is determined by calculating an average vertical offset amongst all or some sub-set of the lidar point pairs. In another example, the interface between the adjacent polygons may be divided into segments and an individual polygon offset may be determined for each segment.

Although embodiments are described herein as determining vertical offsets, embodiments are not limited thereto. The systems and methods described herein can also be used to determine lateral offsets (i.e., offsets in the x- and/or y-directions).

The polygon offset is used to determine one or more correction factors that can be applied to adjacent lidar data sets to remove positional offsets, such as vertical offsets. As an example, the correction factor may be applied to raise and lower adjacent lidar data sets so that the ledge/drop-off at the interface between the adjacent lidar data sets is reduced or eliminated. Referring to FIG. 3, the correction factor may be applied to raise the first lidar data set represented by the first polygon 202 and to lower second lidar data set represented by the second polygon 204. For example, the correction factor may be applied to each lidar point within the adjacent lidar data sets to either raise or lower the individual lidar points as the case may be.

In some embodiments, the polygon offsets and/or the individual vertical offsets of the lidar point pairs are used to generate a visual representation on an electronic display that shows positional offsets. For example, the display may show portions of an HD map with the perimeters of the polygons having a color that represents a degree of vertical offset. For example, dark red may indicate a high degree of vertical offset between adjacent polygons/lidar data sets, and light blue may represent a low degree of vertical offset between adjacent polygons/lidar data sets. As another example, only polygons/lidar data sets having a positional offset above a threshold may be colored or otherwise highlighted. The display allows a user to see where problems within the HD map are located so that corrective action may be taken. For example, the user may identify problematic areas and take corrective action by manually correcting the HD map, applying a correction factor as described above, or commissioning a new lidar scan of the area.

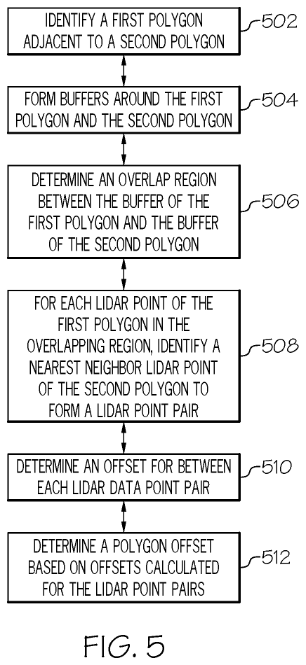

Referring now to FIG. 5, a flowchart of an example method for resolving positional offsets between adjacent lidar data sets is illustrated. At block 502, adjacent polygons are identified, such as a first polygon that is adjacent to a second polygon. As described in detail above, the polygons are formed by generating concave hulls around individual lidar data sets of an HD map. At block 504 buffers are formed around the adjacent polygons. This operation may be performed by expanding the concave hull of each polygon by some value to thereby uniformly expand the area of the polygon. The expansion of the adjacent polygons forms an overlapping region between the buffers of the respective polygons at block 506.

Next, at block 508, lidar point pairs are determined for all (or some sub-set) of lidar points within the adjacent polygons. The lidar point pairs are determined based on a nearest neighbor algorithm. Thus, for a lidar point in the first polygon, its nearest neighbor lidar point in the second polygon is its corresponding lidar point of the lidar point pair. The nearest neighbor algorithm may be any known or yet-to-be-developed nearest neighbor algorithm that determines the closest lidar point of a first lidar data set to a lidar point in a second lidar data set.

At block 510 the lidar point pairs are analyzed for positional offsets. For example, an x-direction offset, a y-direction offset and/or a z-direction offset may be determined. The offset value represents a distance in one or more dimensions that the points of the lidar point pairs are offset from one another. The z-direction offset represents a vertical offset between the two points of a lidar point pair.

In some embodiments, the method moves to block 512, where an overall polygon offset is determined from the individual offset values of the lidar point pairs. This may be calculated by taking an average of the offset values of the lidar point pairs, or performing another function to arrive at the polygon offset value. A correction factor may then be derived from the polygon offset value, and applied to the respective lidar data sets to remove or substantially minimize any positional offsets between the adjacent lidar data sets. In some embodiments, the polygon offset and/or the offset values of individual lidar point pairs are used to display a map showing the locations and severity of the positional offsets that are present.

The resulting corrected HD map may be provided to vehicles, such as autonomous vehicles. Autonomous vehicles may use the HD map to autonomously generate vehicle trajectories to navigate an environment without human intervention.

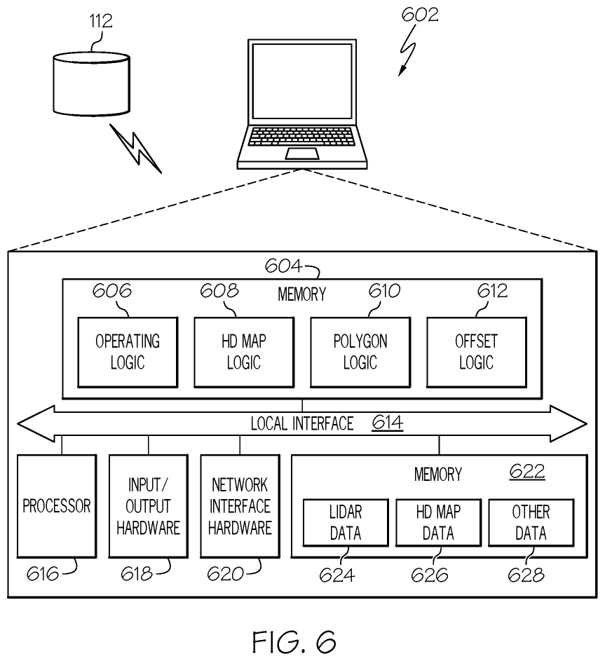

Embodiments of the present disclosure may be implemented by a computing device, and may be embodied as computer-readable instructions stored on a non-transitory memory device. Referring now to FIG. 6, an example system for resolving positional offsets between adjacent lidar data sets as a computing device 602 is schematically illustrated. The example computing device 602 provides a system for resolving positional offsets between adjacent lidar data sets, and/or a non-transitory computer usable medium having computer readable program code for resolving positional offsets between adjacent lidar data sets embodied as hardware, software, and/or firmware, according to embodiments shown and described herein. While in some embodiments, the computing device 602 may be configured as a general purpose computer with the requisite hardware, software, and/or firmware, in some embodiments, the computing device 602 may be configured as a special purpose computer designed specifically for performing the functionality described herein. It should be understood that the software, hardware, and/or firmware components depicted in FIG. 6 may also be provided in other computing devices external to the computing device 602 (e.g., data storage devices, remote server computing devices, and the like).

As also illustrated in FIG. 6, the computing device 602 (or other additional computing devices) may include a processor 616, input/output hardware 618, network interface hardware 620, a data storage component 622 (which may include lidar data 624 (e.g., data generated by a lidar scanner 112), high definition HD map data 626 (e.g., data including lidar data sets, vector data within a vector layer, and other map data), and any other data 628 for performing the functionalities described herein), and a non-transitory memory component 604. The non-transitory memory component 604 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the non-transitory memory component 604 may be configured to store operating logic 606, HD map logic 608 for creating a HD map from the lidar data, polygon logic 610 for forming polygons around lidar data sets as well as creating buffers, and offset logic 612 for calculating offset values for lidar point pairs and between individual adjacent polygons, as described herein (each of which may be embodied as computer readable program code, firmware, or hardware, as an example). It should be understood that the data storage component 622 may reside local to and/or remote from the computing device 602, and may be configured to store one or more pieces of data for access by the computing device 602 and/or other components.

A local interface 614 is also included in FIG. 6 and may be implemented as a bus or other interface to facilitate communication among the components of the computing device 602.

The processor 616 may include any processing component configured to receive and execute computer readable code instructions (such as from the data storage component 622 and/or non-transitory memory component 604). The input/output hardware 618 may include virtual reality headset, graphics display device, keyboard, mouse, printer, camera, microphone, speaker, touch-screen, and/or other device for receiving, sending, and/or presenting data. The network interface hardware 620 may include any wired or wireless networking hardware, such as a modem, LAN port, wireless fidelity (Wi-Fi) card, WiMax card, mobile communications hardware, and/or other hardware for communicating with other networks and/or devices, such as the lidar scanner 112.

Included in the non-transitory memory component 604 may be the operating logic 606, HD map logic 608, polygon logic 610, and offset logic 612. The operating logic 606 may include an operating system and/or other software for managing components of the computing device 602. Similarly, the HD map logic 608 may reside in the non-transitory memory component 604 and may be configured to generate a high definition map from lidar data. The polygon logic 610 also may reside in the non-transitory memory component 604 and may be configured to generate the polygons (i.e., concave hulls) around the lidar data sets as well as the buffers that expand the polygons to generate the overlapping regions. The offset logic 612 includes logic to determine the lidar point pair offsets as well as the polygon offsets.

The components illustrated in FIG. 6 are merely exemplary and are not intended to limit the scope of this disclosure. More specifically, while the components in FIG. 6 are illustrated as residing within the computing device 602, this is a non-limiting example. In some embodiments, one or more of the components may reside external to the computing device 602.

It should now be understood that embodiments of the present disclosure are directed to systems and methods for resolving positional offsets between adjacent lidar data sets, thereby providing more accurate high-definition maps. Embodiments form polygons by determining the concave hulls of lidar data sets, and then expand those polygons by a buffer. Overlapping regions between the buffer regions of adjacent polygons are determined. Those lidar points within the overlapping regions are used to determined lidar point pairs. Positional offset values are determined (e.g., vertical offset values) for the lidar point pairs, and are used to determine an overall polygon offset value. The resulting polygon offset value may be used to determine a correction factor that is used to correct any positional offsets between adjacent lidar data sets, and/or to display positional offsets in a map on an electronic display. It is noted that the use of buffers and overlapping regions to select the lidar points for evaluation significantly reduces the computing time and researches to determine the positional offsets by reducing the amount of data analyzed.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method for resolving positional offsets between adjacent lidar data sets, the method comprising:
defining a first polygon for a first lidar data set and defining a second polygon for a second lidar data set;
forming a first buffer around the first polygon and a second buffer around the second polygon;
defining an overlap region between the first buffer and the second buffer;
for each lidar point of the first lidar data set or the second lidar data set within the overlap region, determining a lidar point pair by finding a nearest neighbor of the other of the first lidar data set or the second lidar data set;
determining a positional offset for each lidar point pair; and
determining a polygon offset based at least in part on the positional offsets for the lidar point pairs.

2. The method of claim 1, wherein the positional offset is a vertical offset.

3. The method of claim 1, wherein the positional offset is a lateral offset.

4. The method of claim 1, wherein the first lidar data set and the second lidar data set represent a road.

5. The method of claim 1, further comprising applying a correction factor to one or both of the first lidar data set and the second lidar data set based at least in part on the polygon offset.

6. The method of claim 1, further comprising displaying a visual representation of the polygon offset between the first polygon and the second polygon.

7. The method of claim 1, wherein the first polygon is defined by forming a first concave hull around lidar points of the first lidar data set and the second polygon is defined by forming a second concave hull around lidar points of the second lidar data set.

8. A system for resolving positional offsets between adjacent lidar data sets, the system comprising:
one or more processors; and
a memory storing instructions that, when executed by the one or more processors, cause the one or more processors to:
define a first polygon for a first lidar data set and defining a second polygon for a second lidar data set;
form a first buffer around the first polygon and a second buffer around the second polygon;
define an overlap region between the first buffer and the second buffer;
for each lidar point of the first lidar data set or the second lidar data set within the overlap region, determine a lidar point pair by finding a nearest neighbor of the other of the first lidar data set or the second lidar data set;
determine a positional offset for each lidar point pair; and
determine a polygon offset based at least in part on the positional offsets for the lidar point pairs.

9. The system of claim 8, wherein the positional offset is a vertical offset.

10. The system of claim 8, wherein the positional offset is a lateral offset.

11. The system of claim 8, wherein the first lidar data set and the second lidar data set represent a road.

12. The system of claim 8, wherein the instructions further cause the one or more processors to apply a correction factor to one or both of the first lidar data set and the second lidar data set based at least in part on the polygon offset.

13. The system of claim 8, further comprising an electronic display, wherein the instructions further cause the one or more processors to display a visual representation of the polygon offset between the first polygon and the second polygon on the electronic display.

14. The system of claim 8, wherein the first polygon is defined by forming a first concave hull around lidar points of the first lidar data set and the second polygon is defined by forming a second concave hull around lidar points of the second lidar data set.

15. A system for resolving positional offsets between adjacent lidar data sets, the system comprising:
a lidar scanner operable to scan an environment to generate lidar points that define lidar data sets;
one or more processors; and
a memory storing instructions that, when executed by the one or more processors, cause the one or more processors to:
receive lidar points from the lidar scanner, wherein the lidar points define a first lidar data set and a second lidar data set;
define a first polygon for the first lidar data set and define a second polygon for the second lidar data set;
form a first buffer around the first polygon and a second buffer around the second polygon;
define an overlap region between the first buffer and the second buffer;
for each lidar point of the first lidar data set or the second lidar data set within the overlap region, determine a lidar point pair by finding a nearest neighbor of the other of the first lidar data set or the second lidar data set;
determine a positional offset for each lidar point pair; and
determine a polygon offset based at least in part on the positional offsets for the lidar point pairs.

16. The system of claim 15, wherein the positional offset is a vertical offset.

17. The system of claim 15, wherein the instructions further cause the one or more processors to apply a correction factor to one or both of the first lidar data set and the second lidar data set based at least in part on the polygon offset.

18. The system of claim 15, wherein the first lidar data set and the second lidar data set represent a road.

19. The system of claim 15, further comprising an electronic display, wherein the instructions further cause the one or more processors to display a visual representation of the polygon offset between the first polygon and the second polygon on the electronic display.

20. The system of claim 15, wherein the first polygon is defined by forming a first concave hull around lidar points of the first lidar data set and the second polygon is defined by forming a second concave hull around lidar points of the second lidar data set.
